(19) United States
(12) Patent Application Publication
(10) Pub. No.: US 2011/0061633 A1
(43) Pub. Date: Mar. 17, 2011

(54) Internal combustion engine having intake manifold combined with holding tank

(76) Inventor: Barnett Joel Robinson, Newton, MA (US)

(21) Appl. No.: 12/586,025

(22) Filed: Sep. 16, 2009

(51) Int. Cl. F02B 33/00; F02M 35/10

(52) U.S. Cl. 123/559.1; 123/184.54

(57) ABSTRACT

An internal combustion engine with a plurality of cylinders operating in a four-stroke mode, with pistons moving with reciprocating motion, employs at least one holding tank that is formed within a branch of an intake manifold. The holding tank may be shared among a plurality of cylinders. The holding tank, in response to an opening and a closure of a holding valve within the manifold, serves alternately as a conduit and a tank to convey a pre-combustion gas (fuel-air mix in gasoline engines) to and from the cylinders. Intake valves are held open beyond termination of induction strokes for entry and extraction a quantity of pre-combustion gas from a cylinder to reduce the compression ratio to a value less than the expansion ratio.

### FIELD OF THE INVENTION

This invention relates to an internal combustion engine having a cylinder with a translating piston therein, and employing a holding tank connecting, via a valve, to the combustion chamber of the cylinder for providing that the expansion ratio of an expansion (power) stroke is greater than the compression ratio of a compression stroke, and wherein the holding tank is combined with an intake manifold.

### BACKGROUND OF THE INVENTION

An internal combustion engine, wherein an elevated expansion ratio is provided by utilization of a holding tank, is described in U.S. Pat. No. 6,907,859 of B. J. Robinson (Robinson), the inventor of the present invention. For appreciation of the present invention, it is useful to review the operations of the four-stroke form of the gasoline engine and the diesel engine, and particularly the description of the Robinson engine. Information on the construction of the engine, disclosed in the Robinson patent, is incorporated herein by reference.

In the four-stroke form of the gasoline engine, the movement of a piston in its cylinder is characterized by four strokes of the piston, in conjunction with operation of an intake valve and an exhaust valve generally located in the cylinder head. The four strokes occur in a repeating sequence, the sequence of the four strokes being: an induction stroke, a compression stroke, a power (or expansion) stroke, and an exhaust stroke. During the induction stroke, the piston moves away from the head of the cylinder to produce a vacuum that draws in a mixture of air and fuel vapors via the intake valve. During the compression stroke, the intake and the exhaust valves are closed, and the piston moves towards the cylinder head to compress the air-fuel mixture. Approximately at the beginning of the power stroke, there is ignition of the air-fuel mixture and, during the power stroke, the expanding gases produced by the combustion of the fuel drive the piston away from the cylinder head. During the exhaust stroke, the piston moves towards the cylinder head to drive the exhaust gases out of the cylinder via the exhaust valve. In the usual construction of such an engine, an intake manifold is provided for bringing air and fuel from a carburetor or fuel-injection assembly to the intake ports of the cylinders, and an exhaust manifold is provided for removal of combustion gases via exhaust ports of the cylinders.

It is useful to compare operation of the gasoline engine with the diesel engine. In the case of the gasoline engine, both fuel and air are present in the cylinder during the compression stroke. The temperature produced in the gases within the cylinder is below the ignition temperature of the air-fuel mixture so as to avoid premature ignition of the air-fuel mixture. Ignition is produced by an electric spark of a spark plug, mounted within the cylinder head. In a modern engine, activation of the spark plug at an optimum moment, relative to the time of occurrence of the power stroke, is provided by a computer. In the case of the diesel engine, only the air is present in the cylinder during the induction and the compression strokes. The geometry of the piston within the cylinder of the diesel engine differs somewhat from the corresponding geometry of the gasoline engine such that the compression stroke of the diesel engine provides significantly more compression of the gases within the cylinder (a compression ratio of approximately 15:1, or higher) than occurs in the gasoline engine (a compression ratio of approximately 8:1). As a result, in the diesel engine, the temperature of the air is raised by the compression stroke to a temperature high enough to ignite fuel. Accordingly, in the diesel engine, the fuel is injected into the cylinder at approximately the beginning of the power stroke, and is ignited by the high air temperature.

It is observed furthermore, that in the usual construction of a gasoline engine and of a diesel engine, the ratio of the expansion of the volume of cylinder gases, final volume divided by initial volume of the power stroke, is equal to the ratio of the compression of the volume of the cylinder gases, initial volume divided by final volume of the compression stroke, for engines without the feature of elevated expansion ratio provided in the Robinson patent. The expansion of the cylinder gases in the power stroke is accompanied by a reduction in the temperature of the cylinder gases. Well-known theoretical considerations show that an important consideration in determining the efficiency of the engine is the ratio of the gas temperature at the beginning of the power stroke to the gas temperature at the end of the power stroke. A greater temperature ratio is obtained in the case of the diesel engine than for the gasoline engine. This is one of the reasons that the diesel engine can operate more efficiently than the gasoline engine.

The engine of Robinson (U.S. Pat. No. 6,907,859) includes, for each cylinder, an intake valve and an outlet valve, and furthermore includes a return valve, a discharge valve, a return manifold, and a holding tank. The return valve closes and opens a passage between the internal space of a cylinder and its holding tank, and the discharge valve closes and opens a passage between the holding tank and the return manifold. In Robinson (U.S. Pat. No. 6,907,859), the holding tank is formed within an arm of the return manifold, the return valve is located in a return port of the cylinder head at an outboard end of the manifold arm, and the discharge valve is located at the inboard end of the manifold arm adjacent to a central chamber of the return manifold. In the case of a gasoline engine, this arrangement allows the engine gasses, stored in the holding tank, to be recirculated via the return manifold, back to the carburetor (or fuel injection assembly) to be reinserted into the cylinders of the engine. The function of the holding tank, in conjunction with the additional valves and the return manifold, is to give the engine an elevated expansion ratio while simultaneously being able to reduce the compression ratio for additional fuel savings.

As an alternative mode of withdrawal of the gasses from the cylinder during the compression stroke, for reinsertion of the gasses into the cylinder during a subsequent induction stroke, Robinson (U.S. Pat. No. 7,559,317) discloses a construction of the holding tank with a single port, operative with a valve for communicating with the cylinder for ingress and egress of gasses to be used in the combustion process.

In yet a further mode of withdrawal and reinsertion of the gasses of a cylinder via a holding tank, Robinson (U.S. Pat. No. 7,559,317) discloses the sharing of a holding tank among a plurality of cylinders for a bank of cylinders having a specific configuration. In the engine having this configuration, there is plurality of cylinders, sharing a common cylinder head, and wherein their respective pistons operate in the four stroke engine cycle, and wherein (1) two of the pistons translate within their respective cylinders in unison such that both the first and the second pistons are moving towards the cylinder head concurrently, and (2) the operation of the second piston is delayed from the operation of the first piston by one half of the four stroke cycle. By way of example, the intake stroke of the first piston occurs concurrently with the power stroke of the second piston. This embodiment of the invention enables the two cylinders to share a single holding tank located within their common cylinder head. Return valves in each of the two cylinders provide communication with the single shared holding tank. This feature of the invention provides for a still further reduction in the number of components of the engine to simplify construction of the engine, while retaining the feature of the elevated compression ratio, and also enables all of the valves to be constructed in a valve assembly sharing a common housing that also contains the holding tank shared by the two cylinders.

The engine of Robinson (U.S. Pat. No. 6,907,859) can be modified, as taught in Robinson (Pub. U.S. Pat. Application No. 20080087257) to provide a reduction in physical size by sharing a single holding tank with a plurality of engine cylinders. This arrangement of the engine differs from Robinson (U.S. Pat. No. 7,559,317) in that an individual holding tank is provided with a discharge valve for recirculating gasses from the holding tank, via a return manifold, back to the carburetor (or fuel injection assembly) of a gasoline engine for reinsertion into the engine cylinders. In such a sharing arrangement, the following conditions apply, namely, (1) that the discharge valve is closed when any one of the return valves, associated with the sharing cylinders, is open; and (2) that only one of the return valves, associated with the sharing cylinders, is open at any one time.

Robinson (Pub. Pat. Application No. 20080087257) provides an example in the sharing of the holding tank for the case of an in-line four-cylinder engine, wherein the four cylinders share a common cylinder head, and wherein their respective pistons operate in the four-stroke engine cycle, the four cylinders are arranged in two groups each having two cylinders. The two cylinders in a first of the two groups share a first of two holding tanks, and the two cylinders in the second of the two groups of cylinders share a second of the two holding tanks. In each group of the two cylinders, two of the pistons translate within their respective cylinders in unison such that both the first and the second pistons are moving within their respective cylinders towards the cylinder head concurrently. In this configuration of the engine, the operation of a second piston is delayed from the operation of the first piston by one half of the four-stroke cycle, the delay being equivalent to 360 degrees of crankshaft rotation.

In such an engine, with respect to the operation of each of the two cylinder groups, the compression stroke of the first piston occurs concurrently with the exhaust stroke of the second piston. This embodiment of the engine enables the two cylinders to share a single holding tank located within their common cylinder head because the return valve associated with the first of the two pistons is open (during a portion of the compression stroke) when the return valve associated with the second of the two pistons is closed (during the exhaust stroke). The discharge valve, located at an exit of the common holding tank, has the opportunity to open during a portion of the intake stroke of either one of the two cylinders, this corresponding to the time of occurrence of the expansion (power) stroke in the other of the two cylinders. In this way, the operation of the first cylinder with its first piston and the common holding tank can take place without interference from the operation of the second cylinder with its second piston and the common holding tank.

Furthermore, in the foregoing engine, with respect to the outputting of gas from each of the holding tanks to the return manifold, it is noted that the movements of the pistons in the second of the cylinder groups is delayed from the piston movement of the first cylinder group by one quarter of the four-stroke cycle. As a result, the operations of the two discharge valves associated respectively with the two holding tanks are staggered, such that the one discharge valve is open only during a period of time when the other discharge valve is closed. This provides for a uniform pattern in the flowing of gasses from the two holding tanks into the return manifold for enhanced operation of the engine.

With the arrangements disclosed in both Robinson (U.S. Pat. No. 7,559,317) and Robinson Pub. Pat. Application (No. 20080087257) the height of the engine can be reduced by building the holding tank(s) in a pancake shape wherein a tank extends transversely of the cylinder block with a relatively small dimension in terms of the height of the tank(s). It is recognized that, as a practical matter, a holding tank may have an irregular shape to conform to the layout of other components (such as valve stems, oil passages, and coolant passages, by way of example) in a particular construction of engine.

### SUMMARY OF THE INVENTION

It is an object of the present invention, as set forth in the appended claims, to provide for increased efficiency in the operation of an internal combustion engine while providing for a reduction in the physical size and complexity of a gasoline engine employing a holding tank.

Before proceeding further in a description of the physical features of an engine embodying the present invention, as set forth in the appended claims, it is useful to distinguish the nomenclature and various aspects of the embodiments of the engines, discussed in the aforementioned patent documents of Robinson, from the descriptive material to be provided hereinafter in the discussion embodiments of the presently claimed engine.

There are two significant aspects of the embodiments of the four-stroke engines of the foregoing Robinson patent documents which are also to be considered in construction of embodiments of the present four-stroke engine. The first aspect is the operation of the power (or expansion stroke), and the second aspect is the utilization of two strokes, namely the induction stroke and the “compression” stroke to prepare the combustion chamber with an appropriate amount of fuel and air along with a mode of igniting the fuel. The term compression is placed in quotation marks because the amount of compression employed in the present engine is much reduced from the compression described in the foregoing engines of the Robinson patent documents.

The term diesel engine is employed in the teachings of the foregoing Robinson patent documents. A feature of the diesel engine is the elongated piston within a cylinder having a bore length associated with the gasoline engine. The resulting geometry gives an enlarged expansion ratio of 1:15 (or greater) for the diesel engine rather than the usual ratio of 1:8 for the gasoline engine. The presently claimed invention is operative with both high and low values of the expansion ratio (such as 1:15 and 1:8) and other ratios that may be desired. The elongated piston is to be employed in a preferred embodiment of the claimed invention because the enlarged expansion ratio provides for improved fuel efficiency in the operation of the engine.

However, the provision of the elongated piston with its enlarged expansion ratio does not, by itself, create a diesel engine. The traditional diesel engine employs the intake stroke for bringing air into the combustion chamber, this being followed by utilization of the compression stroke to compress the air by a compression ratio equal to 15:1, which is the reciprocal of the expansion ratio in a diesel engine. The high compression of the compression stroke raises the air to the fuel ignition temperature, so that, upon injection of the fuel directly into the cylinder with the piston at top dead center, the fuel begins to burn for operation of the power stroke. For ease of reference, this form of ignition may be described hereinafter as compression ignition, as distinguished from spark ignition which is attained with the aid of a spark plug.

In accordance with an understanding of the operation of the engine of the presently claimed invention, it is recognized that such high compression of the traditional diesel engine is unnecessary for preparation of the combustion chamber with an appropriate amount of fuel and air, is not necessary for ignition of the fuel, and is highly wasteful of the chemical energy stored in the fuel, particularly in view of the compression stroke providing unnecessary functions. Thus, the presently claimed invention does not employ such a high compression ratio in the “compression” stroke, does not raise the compressed air to ignition temperature, but employs spark ignition, such as by an electrically operated spark plug in the traditional gasoline engine. Also, the fuel is not injected into the cylinder, as in the traditional diesel engine, but is introduced well before the induction stroke, as by carburetion or fuel injection, to provide ample opportunity for a good mixing of the fuel with the air, which mixing encourages a more complete combustion of the fuel in the air.

In view of the above-described significant departure of the construction of the present engine of the claimed invention from that of the diesel engine, except for the elongated piston which is retained, the present engine may be referred to as a spark-ignition engine. The engine, in view of the spark ignition, may burn a variety of fuels that can be mixed with air, as by a carburetion process, such as octane gasoline, heating oil, and diesel fuel, by way of example.

With respect to the amount of charge, the fuel-air mix, placed in the combustion chamber prior to the power stroke, it is noted that for a relatively small charge, as well as for a relatively large charge, the expansion ratio is still the above-noted 1:15 (for the preferred embodiment), or such other value such as 1:20 that may be established by geometrical relationship between piston height and cylinder bore length. Accordingly, in a preferred embodiment of the claimed invention, a relatively small (or reduced) compression ratio, on the order 4:1 or 5:1, by way of example, may be employed to place a reasonable amount of charge in the combustion chamber. The engine enjoys the efficiency associated with the high expansion ratio, and the engine enjoys the further efficiency gained by avoiding compression of air to ignition temperature. Thus, the engine avoids the mechanical work of the piston in the compression stroke, which work is converted to thermal energy of heated air, and wherein a major portion of the thermal energy of the heated air is lost to the water jacket (designed to remove heat from the cylinder).

With the foregoing concepts in mind, the physical description of the engine of the claimed invention is now provided.

The foregoing object of increased efficiency and reduced complexity is attained by operating the spark ignition engine with the reduced compression ratio obtained by implementation of a holding tank, and wherein at least a part of an intake conduit (or pipe) serves as the holding tank in an embodiment employing a single cylinder, or wherein at least a part of a manifold shared among plural cylinders serves as the holding tank in a further embodiment of the engine constructed of a plurality of cylinders.

As a feature of this integral construction of an intake conduit with a holding tank, or of an intake manifold with a holding tank, the intake valve for an individual one of the cylinders performs both the function of an intake valve plus the function of a return valve. Accordingly, the return valve in the cylinder head for each of the cylinders (described above in the referenced Robinson patent documents) is omitted in the engine of the presently claimed invention, this resulting in still further reduction in complexity of the valve assembly. In the case of an intake manifold shared among two cylinders of a four-stroke engine, the operations of the pistons of the two cylinders must be separated by a full revolution of the engine crankshaft so as to insure that the timing of an induction stroke of one piston does not scavenge an air-fuel mixture from a compression stroke of the second piston. Ideally, for a multi-cylinder engine, one may consider a four-cylinder in-line engine with two manifolds (one for the #1 and #4 pistons, and one for the #2 and #3 pistons) that can be operated with relatively small pulsations of intake vacuum at the throat of a carburetor, by way of example.

In the case of an engine wherein a single intake conduit is applied to a single cylinder (no sharing of a manifold), a holding valve can be employed within or at the beginning of the intake manifold/holding tank combination (or other source of fuel-air mixture) to avoid excessive pulsations in intake vacuum at the throat of the carburetor. The holding valve must be closed when the intake valve is open during the compression stroke. At all other times of the engine's operation, the holding valve may be open or closed, in accordance with the specific function being performed by the holding valve as will be explained in further detail hereinafter.

The deletion of the return valve provides the following benefits. First, it is recognized that a designer of the cylinder head has freedom in the selection of the sizes and placements of the intake and the exhaust valves, without having to be concerned with the placement of the return valve. Secondly, it is recognized that the three manifolds of the prior art are reduced to only two manifolds, namely, the exhaust manifold, and a further manifold which serves the dual functions of an intake manifold and a holding tank. Thus, the overall size of the engine is reduced, allowing for a reduction both in costs of engine construction, as well as in the size of the engine compartment of a motor vehicle. An immediate consequence is improved visibility provided to a driver of the vehicle.

With respect to each of the engine cylinders, the function of the intake valve is performed by opening the intake valve at the beginning of the induction stroke. The function of the return valve is performed by maintaining the open state of the intake valve during a major portion of the compression stroke to permit a portion of the engine gases received from the intake manifold, during the intake stroke, to flow back to the intake-manifold/holding-tank combination during said major portion of the compression stroke. Thereupon, the intake valve is closed, and the intake manifold serves as the holding tank for holding the engine gases. The intake valve remains closed throughout the remainder of the compression stroke, the power stroke, and the exhaust stroke.

The exhaust valve is closed during the intake stroke, the compression stroke, and a major portion of the power stroke. The exhaust valve may be opened during a terminal phase of the power stroke (as taught in Robinson U.S. Pat. No. 7,040,264), and remains open during the exhaust stroke. Thus, the amount of the charge of the engine gases from the induction stroke, remaining after closure of the intake valve, is contained with the cylinder, in view of the closure of both the intake and the exhaust valves, and is compressed by the compression stroke in preparation for combustion of fuel during the power stroke.

In a preferred embodiment of the invention, the portion of the intake manifold, which serves also as a holding tank, has a volume that is related to the maximum volume of the combustion chamber of a cylinder by a volumetric factor (ratio of tank volume divided by chamber volume) in the range of 1.0 to 1.5. The combustion chamber is defined as the space enclosed within the cylinder wall from the top surface of the piston to the interior surface of the cylinder head. The maximum volume of the combustion chamber is attained with the piston being located at bottom dead center. Also, in the preferred embodiment of the invention, the portion of the intake manifold serving as the holding tank has a volume defined by the enclosed space of the manifold located between the intake valve of a cylinder and a holding valve located within the intake manifold. Alternatively, the holding valve may be located between the intake valve and a turbocharger or supercharger located at the beginning of the intake manifold, or between the intake valve and the air filter if no turbocharger or supercharger is placed between the air filter and the intake manifold. By way of example, with respect to a volumetric factor of 1.5 in the case where a cylinder's combustion chamber has a maximum volume of one liter, then the holding valve is located in the intake manifold at a location providing for 1.5 liters for the holding tank.

In accordance with a feature of the invention, the holding valve is open during the induction stroke to enable a fuel-air mixture to flow from a source of fuel-air mixture, such as a carburetor or fuel-injector assembly, via the intake manifold and the open intake valve into the cylinder. The holding valve closes upon termination of the induction stroke to convert the above-noted portion of the intake manifold into the holding tank. Thereby, during the initial stage of the compression stroke, when the intake valve is still open, the upward motion of the piston drives a portion of the cylinder charge out through the open intake valve into the holding tank. Subsequently, upon closure of the intake valve, that portion of the cylinder charge that has been forced by the piston into the holding tank remains in the holding tank, in view of the closed state of both the holding valve and the intake valve. The charge in the holding tank stays there until conversion of the holding tank back to the intake manifold by an opening of the holding valve and the intake valve (of the aforementioned cylinder or of a second cylinder sharing the holding tank) at the beginning of an intake stroke. Accordingly, the intake valve begins to open at top dead center of its respective intake stroke, and remains open throughout the intake stroke and during most of the compression stroke, but becomes fully closed prior to ignition of the fuel-air mixture, as by the firing of a spark plug.

It is noted that the portion of the cylinder charge diverted to the holding tank during the compression stroke depends on the time of closure of the intake valve. For example, if the closure of the intake valve is delayed from bottom dead center (of the intake stroke) by ninety degrees of crankshaft rotation, then approximately half of the cylinder charge (air-fuel mix for the gasoline engine) would be diverted to the holding tank by upward movement of the piston during the following compression stroke. For a preferred embodiment of the invention, most beneficial operation is attained by delaying closure of the intake valve to a range of 35 to 60 degrees before top dead center at the termination of the compression stroke. As a result, proportionately less fuel would be burned during the following power stroke, but the engine would run more efficiently because less output power of the engine would be diverted from useful work to the compression of the cylinder charge during the compression stroke.

The compression ratio in a preferred embodiment of the invention is in the range of approximately 5:1 to 4:1 or possibly less, which ratio is much smaller that the expansion ratio (in either a compression ignition engine or a spark ignition engine). With this arrangement, using a carburetor in a spark ignition engine, there is more fuel-air mixture in the holding tank than in the cylinder at the time of ignition (possibly 80% in the tank versus 20% in the cylinder). This leads to a further efficiency in that the fuel-air mixture spends significant time in the holding tank, providing for improved vaporization and mixing of the fuel with the air prior to the next induction stroke.

The amount of compression during the compression stroke can be selected independently of the amount of expansion during the expansion (power) stroke. By way of example, a compression ratio of 5:1 could be provided during the compression stroke by a suitably long delay in the closing of the intake valve, while an expansion ratio of 15:1 could be provided during the power stroke, the latter value being obtained by use of a relatively tall piston comparable to that of a compression ignition engine rather than the shorter piston associated with the common spark ignition engine. In addition, the advantage of the greater fuel efficiency is obtainable whether the fuel be mixed with the air prior to the compression stroke, as is the case of an engine employing a carburetor with spark ignition, or be injected into the intake manifold at the intake valve, also with spark ignition.

The above description of the implementation of the holding tank applies to an engine having a single cylinder as well as to an engine having multiple cylinders. An example in the case of an engine of multiple cylinders is the case of an in-line four-cylinder engine, wherein the four cylinders share a common cylinder head, and wherein their respective pistons operate in the four-stroke engine cycle, the four cylinders being arranged in two groups each having two cylinders. The two cylinders in a first of the two groups share a first of two intake-manifold holding-tank combinations, and the two cylinders in the second of the two groups of cylinders share a second of the two intake-manifold holding-tank combinations. The sharing of a holding tank is accomplished by constructing the holding tank with two branches of which one branch (constructed as an intake conduit) goes to one cylinder and connects therewith by means of its respective intake valve, and wherein the second branch (constructed as an intake conduit) goes to a second cylinder and connects therewith by means of its respective intake valve.

In each group of the two cylinders, two of the pistons translate within their respective cylinders in unison such that both the first and the second pistons are moving within their respective cylinders towards the cylinder head concurrently. In this configuration of the engine, the operation of a second piston is delayed from the operation of the first piston by one half of the four-stroke cycle, the delay being equivalent to 360 degrees of crankshaft rotation.

In such an engine, with respect to the operation of each of the two cylinder groups, the compression stroke of the first piston occurs concurrently with the exhaust stroke of the second piston, and in corresponding fashion, the induction stroke of the first piston occurs concurrently with the power stroke of the second piston. This enables the two cylinders to share a single holding tank located within their common cylinder head because the intake valve associated with the first of the two pistons is open (during the induction stroke and a portion of the compression stroke) when the intake valve associated with the second of the two pistons is closed (during the power stroke and the exhaust stroke). The holding valve, located at the common holding tank, opens for the induction stroke of a first of the two cylinders followed by closure during the compression stroke of the first cylinder, and opens also for the induction stroke of the second of the two cylinders followed by closure during the compression stroke of the second cylinder. This arrangement in the timing of the intake valves and the holding valve provides that only one of the two intake valves is open at any one time, and that the holding valve is open only when one or the other of the two intake valves is open for the induction portion. In this way, the operation of the first cylinder with its first piston and the common holding tank can take place without interference from the operation of the second cylinder with its second piston and the common holding tank.

### BRIEF DESCRIPTION OF THE DRAWING

The aforementioned aspects and other features of the invention are explained in the following description, taken in connection with the accompanying drawing figures wherein:

FIG. 1 shows a stylized view of an internal combustion engine constructed in accordance with the invention;

FIG. 2 is a timing diagram showing operation of valves and a piston associated with a cylinder of the engine of FIG. 1;

FIG. 3 shows diagrammatically details in the construction of a return manifold connected to a cylinder of the engine of FIG. 1, the figure showing also the inventive feature of a sharing of a holding tank by plural cylinders of the engine;

FIG. 4 is a is a sectional view of a cylinder head with a valve assembly including some of the components of FIG. 3, and further showing an arrangement of intake valve, holding valve, and holding tank constructed within the housing of the valve assembly, and showing further a connection of the holding tank to a neighboring cylinder; and

FIG. 5 is a longitudinal sectional view of a four-cylinder, inline engine block, wherein the two central cylinders share a single holding tank operated with a single holding valve, and the two outer cylinders share a separate holding tank operated with a separate holding valve.

Identically labeled elements appearing in different ones of the figures refer to the same element but may not be referenced in the description for all figures.

### DETAILED DESCRIPTION OF THE INVENTION

A form of the internal combustion engine, generally used for powering automobiles, operates in accordance with the Otto cycle, and may be referred to herein as a spark ignition engine, as distinguished from a compression ignition engine. The spark ignition engine employs one or more cylinders, each cylinder having a piston movable therein with reciprocating motion for the driving of a crankshaft of the engine. Output power of the engine, for the driving of a load, is obtained from the rotating crankshaft. The invention is described now for the four-stroke form of the spark ignition engine.

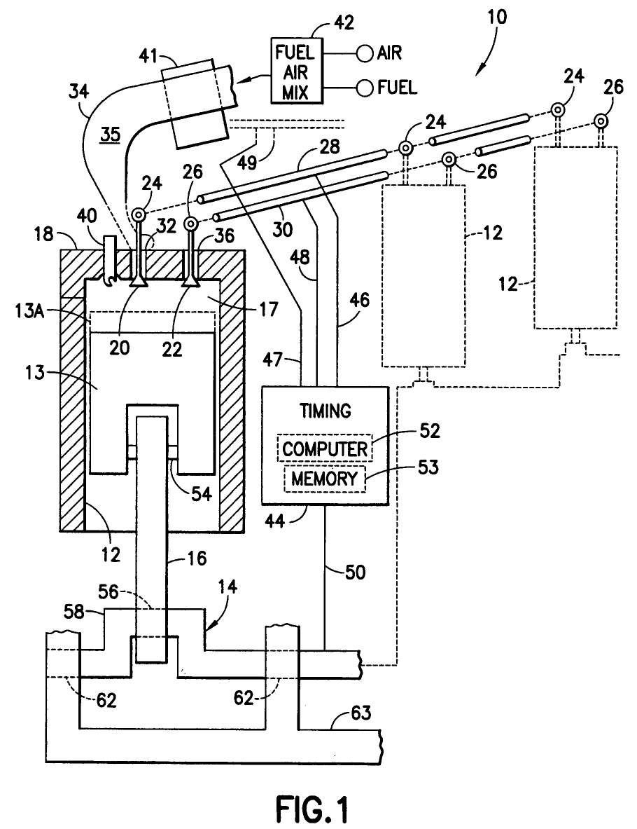

FIG. 1 shows an engine 10 having a plurality of cylinders 12 with pistons 13 therein. One of the cylinders 12 is sectioned to show its piston 13, and the remaining cylinders 12 are shown in phantom view. With respect to an individual one of the cylinders 12, the piston 13 is driven by a crankshaft 14 of the engine 10, and connects by a connecting rod 16 with the crankshaft 14 for reciprocating motion of the piston 13 along an axis of the cylinder during rotation of the crankshaft 14. Motion of the piston 13 is characterized by a repeating sequence of four strokes, as described above. The piston 13 and the cylinder 12 define a combustion chamber 17 which extends within the cylinder 12 from a top surface of the piston 13 to the interior surface of a head 18 of the cylinder 12. During the induction stroke and during the power (or expansion) stroke, the distance between the piston 13 and the head 18 of the cylinder 12 increases to provide for an increase in the volume of cylinder available for containing gases within the cylinder. During the compression stroke and during the exhaust stroke, the distance between the piston 13 and the head 18 decreases to provide for a decrease in the volume of the cylinder available for the containment of gases within the cylinder. Typically, in the construction of the cylinder head 18, the interior of the head 18 may be provided with a complex shape to enhance combustion within the cylinder 12. However, for an understanding of the presently claimed invention, the interior of the cylinder head 18 may be represented by the more simple shape of a right circular cylinder as shown in FIG. 1.

The engine 10 further comprises an intake valve 20, and an exhaust valve 22 located in the cylinder head 18. The valves 20 and 22 are operated, respectively, by cams 24 and 26 of camshafts 28 and 30. It is understood that the two camshafts are provided by way of example, and that, by way of further example, a single camshaft with two cams thereon may be employed (as will be described hereinafter) for operation of the foregoing valves. The intake valve 20 is operative to close and to open an intake port 32 of the head 18. The intake port 32 provides communication between the combustion chamber 17 and an intake manifold 34 of which at least a portion of the ducting serves as a holding tank 35. This feature of the engine enables the ducting of which the intake manifold is constructed to serve the dual functions of intake manifold and of holding tank for a reduction in size of the engine. This feature also allows the intake valve to serve the dual functions of intake valve and return valve. Also, as is shown in FIG. 1, the exhaust valve 22 is operative to close and to open an exhaust port 36 of the head 18. A spark plug 40 is provided in the head 18 for ignition of gases in the cylinder 12.

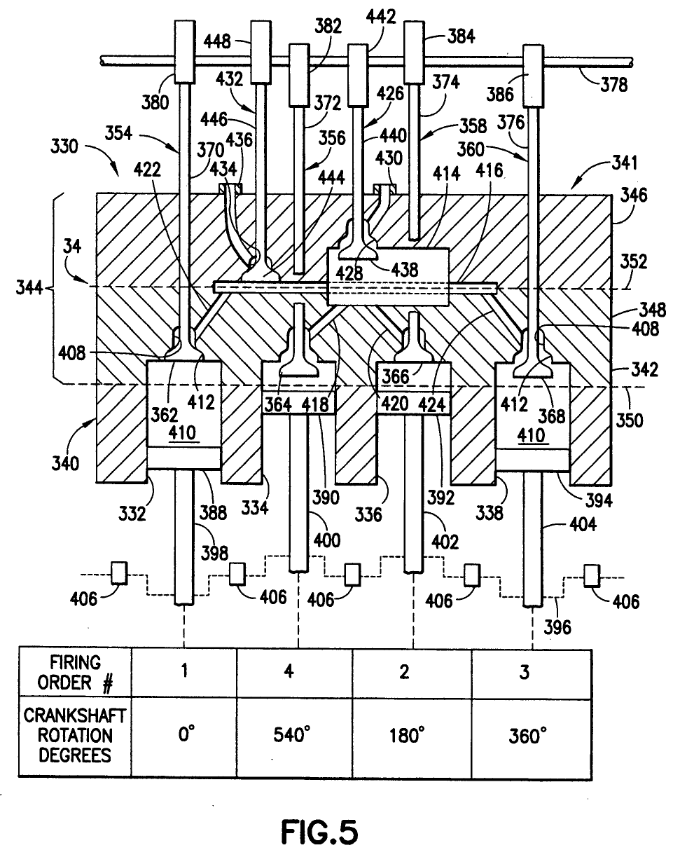

In the intake manifold 34, the portion of the ducting serving as the holding tank 35 is defined as the space between the intake valve 20 and a holding valve 41. In a preferred embodiment of the invention, the holding valve 41 is constructed as a reed valve which is normally closed, but opens under the force of the intake vacuum. In a typical operational sequence of the engine 10, the holding valve, embodied as the reed valve, is responsive to intake vacuum of the induction stroke, the read valve opening in the presence of vacuum at the inception of the induction stroke and closing in the absence of vacuum at the termination of the induction stroke. Thus, the reed valve operates as a one-way valve to allow ingress of gas (air or a mix of air plus fuel) towards the cylinder, but prevents any flow of the gas in the reverse direction, out of the cylinder towards a source of the air-fuel mix, as might occur during a rising of the piston in the compression stroke. Such reed valves, by way of example, are manufactured by MOTO TASSINARI, and are employed typically for two-stroke engines as used in motorcycles. Also, by way of example, FIG. 1 shows a source 42 of fuel-air mix, such as a carburetor, into which air and fuel are inputted to provide the fuel-air mix. By way of alternative embodiments, the holding valve can also be constructed as a rotary valve actuated by a mechanical connection to the crankshaft or to the camshaft to open when its piston or pistons are moving away from the head and to be closed when its piston or pistons are moving toward the head. The actual timing of the opening and closing of this embodiment of the holding valve is the same as the timing of the cam-driven holding valve as will be explained in greater detail with reference to FIG. 5.

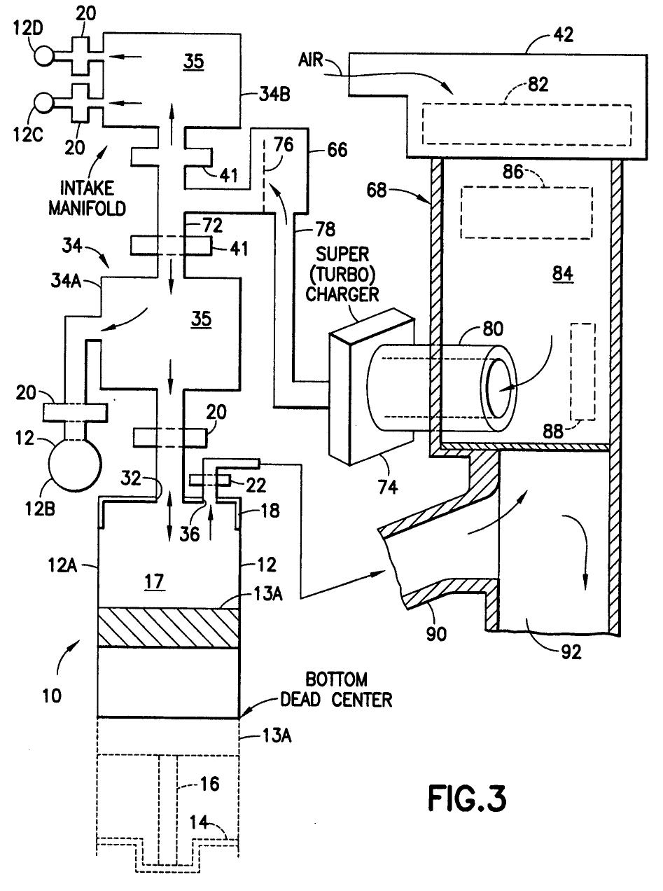

In FIG. 1, the intake manifold 34 is indicated diagrammatically. It is to be understood that the intake manifold 34 is employed in a preferred embodiment of the engine having four cylinders, such as an inline engine (to be described in further detail hereinafter) wherein two of the pistons are moving up concurrently (one for the compression stroke and one for the exhaust stroke) and operate with a first branch 34A (shown in FIG. 3) of the intake manifold 34, and the remaining two pistons are moving down concurrently (one for the induction stroke and one for the power stroke) and operate with a second branch 34B (FIG. 3) of the intake manifold 34. In the case wherein the manifold 34 is constructed of the two branches 34A and 34B, each of the branches is provided with the holding valve 41, as shown in FIG. 3.

It is to be observed that this usage of two manifold branches 34A and 34B is well adapted for the foregoing inline four-cylinder engine, but may not be available for some other configuration of engine. For example, in a five-cylinder four-stroke engine (not shown), there is no sharing of a manifold among a plurality of cylinders but, rather, each cylinder is connected by a separate intake conduit (or pipe) to a source of the fuel-air mix. By way of further example, in the case of a four-stroke engine having only one cylinder (not shown), that cylinder is connected by a single intake pipe to the source of the fuel-air mix; also, in the case of a four-stroke engine having only two cylinders (not shown), each of the two cylinders is connected by a single intake pipe to the source of the fuel-air mix. For ease of describing the various embodiments of the engine of the claimed subject matter, reference may be a made to the intake manifold 34, it being understood that in certain engine configurations the “manifold” may be only a dedicated single conduit or pipe.

As shown in FIG. 1, the engine 10 also includes a timing device 44 for synchronizing rotation of the crankshaft 14 with rotations of the camshafts 28 and 30. Lines 46 and 48 represent, respectively, connections of the timing device 44 to the camshafts 28 and 30. While the preferred construction of the holding valve 41 is the reed valve, as noted above, it is possible to employ via an alternative embodiment a valve driven by a camshaft 49, indicated in phantom, connected via a line 47 to the timing device 44. Line 50 represents connection of the timing device 44 to the crankshaft 14. In the practice of the invention, the driving of the valves 20, 22 may be accomplished by well-known mechanical, hydraulic or electromagnetic apparatus synchronized to the crankshaft 14, which apparatus is represented diagrammatically by the camshafts 28 and 30, and the timing device 44. By way of example, in the case of a mechanical driving of the valves 20, 22, and 41 (in the alternative embodiment of the holding valve 41), the timing device 44 with its connecting lines 46, 47, 48 and 50 may be provided by means of gearing and a timing belt (not shown) which interconnects gears on the crankshaft 14 and on the camshafts 28, 30 and 49 to provide desired rates of rotation and timing of the rotations of the camshafts 28, 30 and 49 relative to the rotation of the crankshaft 14.

By way of further example, in the case of an electromagnetic driving of the valves 20, 22, and 41 (in the alternative embodiment), the timing device 44 may be provided with a computer 52, and a memory 53 for storing data used by the computer 52. The line 50 represents a shaft angle encoder providing instantaneous values of the angle of the crankshaft 14 to the computer 52, and the lines 46 and 48 represent electric motors for rotating the camshafts 28 and 30 in response to drive signals provided by the computer 52. Similarly, in an alternative embodiment of the valve 41, the line 47 represents an electric motor for operation of the valve. By way of example, the memory 53 may store optimum camshaft angles for opening and closing both the intake valve 20, and the exhaust valve 22 as a function of various engine operating conditions such as crankshaft angle and rate of rotation, as well as possibly intake air mass flow rate and accelerator pedal position, by way of example. Based on data stored in the computer memory 53 as well as data provided to the computer 52 by engine sensors, as are well-known, the computer 52 outputs the drive signals to the electric motors for rotating the camshafts 28 and 30 (as well as for operating the valve 41), thereby to operate the valves 20 and 22 at the optimum times, respectively, for accomplishing the induction and holding functions, and the exhaust function. Information stored in the memory 53, with respect to the optimum timing of each of the valves 20 and 22, may be obtained by experimentation. By way of example, in the situation wherein all of the valves 20, 22 and 41 are driven by cam drives under control of the computer 52, variable valve timing may be employed to optimize operations of the respective valves in accordance with the driving conditions of a vehicle.

Connection of the piston 13 to the connecting rod 16 is made by way of a pin 54 that enables the connecting rod 16 to pivot relative to the piston 13. The opposite end of the connecting rod 16 connects with the crankshaft 14 via a journal 56 located in a crank arm 58 of the crankshaft 14, the journal 56 permitting the crankshaft 14 to rotate about its axis relative to the connecting rod 16. The crankshaft 14 is supported by a set of bearings 62, two of which are shown in FIG. 1, located in a housing 63 of the engine 10. The bearings 62 enable the crankshaft 14 to rotate relative to the housing 63.

As has been discussed above, the spark-ignition engine 10, is operable with a piston of relatively short length or an elongated piston, so as to provide a desired value of expansion ratio in the power stroke based on the geometry of the piston 13 relative to the cylinder 12. This is demonstrated in FIG. 1 by increasing the length of the piston 13 to provide for a taller piston 13A as indicated in dashed line. By way of example in the construction of the piston 13, 13A within its cylinder 12, in the case of the engine 10 operating with the four-stroke process, when the piston in the cylinder is at top dead center, there is 1 cm (centimeter) between piston-top and the head. If the length of a stroke is 7 cm, then bottom dead center is 8 cm from piston to head, this resulting in a compression stroke with 8:1 compression ratio and a power stroke expansion ratio of 8:1. This example leads to a further embodiment of the invention that is preferred for obtaining higher efficiency in the power stroke, wherein the piston 13A is made to be 0.5 cm taller than the piston 13. This changes the geometric ratios from a ratio of 8 cm to 1 cm, with corresponding expansion ratio of 8:1, to a ratio of 7.5 cm to 0.5 cm with a corresponding expansion ratio of 15:1 in the power stroke.

The invention establishes a relatively low value of the compression ratio of the compression stroke, the value being in a range of approximately 5:1 to 4:1, though higher or lower compression ratios may be obtained by the engine 10 if desired. The low value of compression ratio is obtained by a modification in the usual operation of an intake valve, such that the intake valve 20, which is open during the induction stroke, is maintained in the open state as the piston 13, 13A passes through bottom dead center in the transition from the induction stroke to the compression stroke. As the piston rises during the compression stroke, the intake valve 20 performs the function of a return valve by letting some of the fuel-air mixture, which is already in the cylinder 12, to be pushed by the piston back into the intake manifold 34. This reduces the amount of the charge of the fuel-air mix in the cylinder. Later, after still further rising of the piston 13, 13A, the intake valve 20 (now functioning as a return valve) closes, trapping a reduced amount of charge of fuel-air mix in the cylinder 12. The resulting charge is compressed by a relatively small amount because there is relatively little further upward movement of the piston 13, 13A as the piston approaches top dead center at the end of the compression stroke.

In a preferred embodiment of the invention, the portion of the intake manifold, which serves also a holding tank, has a volume that is related to the maximum volume of the combustion chamber of a cylinder by a volumetric factor in the range of 1.0 to 1.5. The portion of the intake manifold serving as the holding tank has a volume defined by the enclosed space of the manifold located between the intake valve of a cylinder and the holding valve located within the intake manifold. By way of alternative embodiments, the holding valve may be located between the intake valve and a turbocharger or supercharger (to be described with reference to FIG. 3) located at the beginning of the intake manifold. With respect to a volumetric factor of 1.5, by way of example, in the case where the cylinder combustion chamber has a maximum volume of one liter, then the holding valve is located in the intake manifold at a location providing for 1.5 liters for the holding tank.

The holding valve 41 is open during the induction stroke to enable a fuel-air mixture to flow from the source 42 of fuel-air mixture, such as a carburetor or throttle body, or to enable the air to be inducted where there is a direct fuel-injector assembly, via the intake manifold 34 and the open intake valve 20 into the cylinder 12. The holding valve 41 closes upon termination of the induction stroke to convert the above-noted portion of the intake manifold 34 into the holding tank 35. Thereby, during the initial stage of the compression stroke, when the intake valve is still open, the upward motion of the piston 13 drives a portion of the cylinder charge out through the open intake valve 20 into the holding tank 35. Subsequently, upon closure of the intake valve, that portion of the cylinder charge that has been forced by the piston into the holding tank remains in the holding tank, in view of the closed state of both the holding valve 41 and the intake valve 20, and stays there until conversion of the holding tank back to the intake manifold by the simultaneous or nearly simultaneous opening of an intake valve and its respective holding valve. Accordingly, the intake valve begins to open at top dead center of its respective intake stroke, and remains open through most of the compression stroke, but is to be fully closed prior to ignition of the fuel-air mixture, as by the firing of the spark plug 40.

It is noted that the portion of the cylinder charge diverted to the holding tank 35 during the compression stroke depends on the time of closure of the intake valve 20. For example, if the closure of the intake valve is delayed from bottom dead center by ninety degrees of crankshaft rotation, then approximately half of the cylinder charge (fuel-air mix for the gasoline engine) would be diverted to the holding tank. For a preferred embodiment of the invention, most beneficial operation is attained by delaying closure of the intake valve 20 to a range of 35 to 60 degrees before top dead center at the termination of the compression stroke. As a result, proportionately less fuel would be burned during the following power stroke, but the engine 10 would run more efficiently because less output power of the engine would be diverted from useful work to the compression of the cylinder charge during the compression stroke.

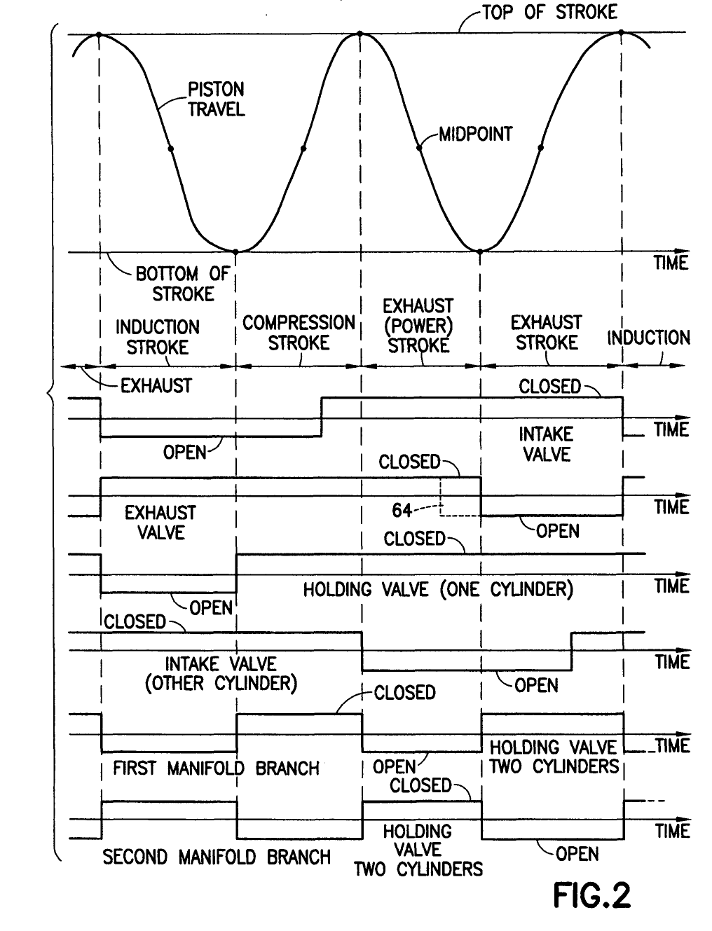

FIG. 2 presents a timing diagram, composed of seven graphs showing the various strokes of the reciprocating motion of the piston within the cylinder, plus the open and the closed positions of various valves with reference to the piston travel. Horizontal axes represent the time, and the seven graphs are in time registration with each other (indicated by dashed vertical lines). In a graph at the top of the diagram, the piston travel is shown as a sinusoidal movement between the top of the stroke and the bottom of the stroke, identified in the figure. The midpoint of a stroke is also identified. The strokes are identified as (1) the induction stroke, wherein the piston travels from the top dead center position, adjacent the cylinder head, to the bottom dead center position, (2) the compression stroke wherein the piston travels from the bottom dead center to the top dead center positions, this being followed by (3) the expansion (or power) stroke wherein the piston travels from the top dead center position to the bottom dead center position, and (4) the exhaust stroke wherein the piston travels from the bottom dead center position to the top dead center position.

In the second graph, the intake valve is shown open during the induction stroke, the open state continuing partway into the compression stroke, with closure occurring during a latter portion of the compression stroke and wherein the closed state is retained during the power and exhaust strokes. The retention of the open state of the intake valve during the initial phase of the compression stroke, which initial phase extends preferably more than half way through the compression stroke, enables the piston to drive out a portion of the intake gas back into the intake manifold 34, more specifically into a portion of the manifold serving as the holding tank 35. This reduces the amount of intake gas (air or air-fuel mix) that is to be compressed during the final stage of the compression stroke, after closure of the intake valve. There results a significant saving in unnecessary work done by the engine to attain greater efficiency of the engine in accordance with a feature of the invention.

In the third graph, the exhaust valve is shown open during the exhaust stroke and closed during the other three strokes. If desired, the exhaust valve may be opened earlier, during a terminal portion of the power stroke such as 30 degrees before the end of the power stroke as is described in most automotive engineering textbooks or as is described in Robinson, U.S. Pat. No. 7,040,264, as indicated in the timing diagram by a dashed line 64.

The fourth graph shows operation of the holding valve 41 (FIG. 1) for a branch of the manifold 34 servicing a single cylinder 12 which, by way of example, might be the first cylinder of a five cylinder engine. The holding valve 41 is open during the induction stroke for passage of intake gas via the manifold and the open intake valve into the cylinder. At the conclusion of the induction stroke, the holding valve is closed and remains closed during the other three strokes.

FIG. 3 presents a diagrammatic view of the inline four-cylinder embodiment of the engine 10 including the intake manifold 34 constructed of the two manifold branches 34A and 34B. One of the cylinders 12 is shown in a detailed view including the intake valve 20 and the intake port 32, the exhaust valve 22 and the exhaust port 36, and the connection of the piston 13A via the connecting rod 16 to the crankshaft 14. For ease of reference, the four cylinders are further identified by the legends 12A, 12B, 12C and 12D. Each of the cylinders 12A and 12B connect via their respective intake valves 20 to the intake manifold branch 34A, and each of the cylinders 12C and 12D connect via their respective intake valves 20 to the intake manifold branch 34B. The specific configuration of the intake manifold 34 depends on the arrangement of components of the engine 10 and, by way of example, the intake manifold 34 may include a central chamber 66 connected to the housing 68 of the fuel-air mixture source 42. Arms 72 connect the central chamber 66 via holding valves 41 to the manifold branches 34A and 34B, wherein one of the holding valves 41 provides a connection from the central chamber 66 to the manifold branch 34A, and another of the holding valves 41 provides a connection from the central chamber 66 to the manifold branch 34B. Connection of the fuel-air mixture source 42 to the intake manifold 34 may be enhanced by a driver 74 of the air-fuel mix, such as a turbocharger or a supercharger, disposed prior to the fuel-air mixture source or air only source or between the fuel-air mixture source 42 and the central chamber 66 of the intake manifold 34. The driver 74 increases the pressure of the intake air-fuel mix applied via the manifold 34 and the intake valves 20 to the cylinders 20. The driver increases horsepower at the flywheel and miles per gallon by reducing the amount of work that the engine has to do by reducing the quantity of sucking action required by the engine to draw into the combustion chambers its respective quantity of air-fuel mix or air only in the case of direct fuel injection.

If desired, the central chamber 66 of the intake manifold 34 may be provided with a mesh 76, as is described in the Robinson U.S. Pat. No. 6,907,859, wherein the mesh 76 extends across the chamber 66 at a location between an inlet passage 78 of the air-fuel mix and an outlet into the set of arms 72. The mesh 76, which may be constructed as a wire screen with apertures therein, functions as an acoustic baffle, as does a corresponding structure in a muffler, to reduce pulsations in the flow or the air-fuel mix associated with the openings and closings of the holding valves 41 and the intake valves 20.

The interior volume of each of the manifold branches 34A and 34B is related to the maximum value of the combustion chamber 17 of a cylinder 12 such that, as noted above, the volume of a manifold branch can have a value which, in a preferred embodiment of the engine 10, falls within a range of approximate equality with the maximum value of the combustion chamber 17 for a ratio of 1:1, to a value that is 50 percent greater than the maximum value of the combustion chamber 17 for a ratio of (1.5):1. As the piston 13A moves upwardly during the compression stroke, the interior volume of the manifold branch provides space for the cylinder intake gas, namely the air or air-fuel mix, driven out by the piston against minimal back pressure, until such time as the closing of the intake valve during the latter portion of the compression stroke. For each of the manifold branches 34A and 34B, the holding valve 41 and the two intake valves 20 define a holding tank 35 for retention of intake gas (air or air-fuel mix). Enlargement of the manifold branch provides the benefit of reducing the pressure to be exerted by the piston for driving out the intake gas so as to reduce work done by the piston. This benefit may have a cost of a larger physical size to the engine to accommodate the larger intake manifold.

Upon closure of the intake valve, the intake gas remaining in the cylinder is compressed during the remainder of the compression stroke. The remainder of the compression stroke is a relatively small fraction of the compression stroke so that the amount of compression actually performed by the piston is on the order 4:1 or 5:1, by way of example. This is sufficient to place a reasonable amount of charge of air-fuel mix in the combustion chamber. As has been noted above, in a preferred embodiment, the most beneficial operation is attained by delaying closure of the intake valve to a range of 35 to 60 degrees before top dead center at the termination of the compression stroke. This provides for a reduction in the amount of fuel to be burned during the following power stroke, but the engine can run more efficiently because less output power of the engine would be diverted from useful work to the process of compressing the cylinder charge during the compression stroke.

With reference again to the graphs of FIG. 2, the fifth graph, in conjunction with the second graph, show operation of two intake valves of two cylinders in the situation wherein the respective pistons of the two cylinders are out of phase by 360 degrees of crankshaft rotation. This is the case of the inline four-cylinder engine (to be described with reference to FIG. 5) in which the first and the fourth of the pistons move upwards concurrently but one of the pistons is performing the compression stroke and the other of the two pistons is performing the exhaust stroke. In corresponding fashion, with respect to the second and the third of the pistons which are moving downwards concurrently, one of the pistons is performing the intake stroke and the other of the two pistons is performing the power stroke. It is noted that the configuration of the fifth graph is the same as the configuration of the second graph, except that the movement of the intake valve of the fifth graph (for the second of the two cylinders) is delayed by 360 degrees of rotation of the crankshaft from the movement of the intake valve of the second graph (for the first of the two cylinders).

The sixth and the seventh graphs of FIG. 2 relate to operation of holding valves, such as the holding valves 41 of FIG. 3, for the inline four cylinder engine of FIG. 5, in which the intake manifold is constructed of a first manifold branch and a second manifold branch, such as the first and the second manifold branches 34A and 34B of FIG. 3. In the construction of FIG. 5, the presentation of the holding valves driven by camshafts demonstrates the relative timing of the various valves and pistons relative to rotation of the camshaft. This timing applies also to the case of a construction of the holding valves in the form of reed valves responsive to the presence of engine vacuum. It is understood that, with respect to the timing of the holding valve, the timing may be via a mechanical drive such as via a cam drive, or alternatively by a sensing of vacuum as in the case of when the holding valve is a reed valve. Each of the intake manifold branches has a holding tank and a holding valve associated with the respective holding tank, as will be described further with respect to a discussion of FIG. 5. Each of the intake manifold branches deals with two of the four cylinders, wherein one of the manifold branches deals with the first and the fourth cylinders, and the other of the manifold branches deals with the second and the third cylinders.

As shown in the sixth graph of FIG. 2, the holding valve of the first intake manifold branch is open during the intake stroke of one of the cylinders for approximately 180 degrees of crankshaft rotation, is then closed for approximately 180 degrees of crankshaft rotation, and repeats the cycle of opening and closing to the intake stroke of the second of the two cylinders. With reference also to the second and the fifth graphs, it is noted that the intake valves of two cylinders serviced by a single intake manifold branch open and close in alternating fashion, such that only one of the two intake valves is open at any one time. Thus, in the operation of the first manifold branch, the holding valve opens to admit intake gas to only one cylinder at a time, and is closed during the compression strokes of each of the two cylinders. In view of the closure of the holding valve during the compression strokes of each of the two cylinders, and in view of the operation of the two intake valves in alternating fashion, the intake gasses driven out of one of the two cylinders during the initial stage of its compression stroke is retained in the holding tank of the manifold branch until such time as the other cylinder begins its intake stroke. In this fashion, intake gas that is driven out of one of the two cylinders during the initial stage of the compression stroke is presented to the other of the two cylinders during its intake stroke.

The seventh graph is similar to the sixth graph, but describes the action of the holding valve for the two cylinders serviced by the second intake manifold branch. The timing of the strokes of the pistons operating in the cylinders associated with the second manifold branch is offset from the timing of the strokes of the pistons operating in the cylinders associated with the first manifold branch by 180 degrees of crankshaft rotation. As a result, the holding valve of the first intake manifold branch opens and closes in alternating fashion with the openings and closings of the holding valve of the second intake manifold branch. This is evident from inspection of the sixth and the seventh graphs. This arrangement of alternating operation of the holding valves of the two manifold branches enhances a smooth flow of intake gas into the cylinders of the inline four-stroke engine of FIG. 5, while enabling operation of the holding tanks of the respective manifold branches for extraction of a portion of the intake gasses from the cylinders during their respective compression strokes.

With reference again to FIG. 3, arrows in the intake manifold 34 show the direction of air flow during the intake stroke for the cylinder 12A when the intake valve 20 is open and the piston 13A is moving down within the cylinder 12A, and similarly for the intake strokes of the other ones of the cylinders 12B, 12C and 12D. In the cylinder 12A, the intake stroke terminates with the piston at bottom-dead-center (BDC), shown in phantom, at which time the holding valve of the manifold branch 34A closes, but the intake valve remains opens as the piston then begins to move upwards in the compression stroke. The direction of the air flow through the intake valve reverses so that the cylinder gas flows from the cylinder 12A back into the manifold branch 34A. This is demonstrated in FIG. 3 wherein the piston 13A at BDC is shown at the halfway point. During the closure of the holding valve 41 for the manifold branch 34A, there is no flow of intake gas between the branch 34A and the central chamber 66. Similarly, during a closure of the holding valve 41 for the manifold branch 34B, there is no flow of intake gas between the branch 34B and the central chamber 66. Furthermore, the operations of the two holding valves 41 are staggered, as shown in FIG. 2, such that an opening of one of the holding valves 41 is accompanied by a closure of the other holding valve 41. Also, as shown in FIG. 2, for any one of the intake manifold branches 34A and 34B, the opening of one of the intake valves 20 is accompanied by a closure of the other intake valve 20. The result is a regular flow of intake gas from the inlet passage 78 of the intake manifold 34, which flow of intake gas has pulsations due to the opening and closures of the intake valves 20 and the holding valves 41, and wherein the pulsations are reduced in intensity by the relatively large spaces of the holding tanks 35 as well as other interior spaces of the intake manifold 34.

With respect to the operation of fuel-air mixture source 42, a conduit 80 enters the housing 68 to make connection between the intake air driver 74 and the interior of the fuel-air mixture source 42. It is noted that the driver 74 is optional. In the event that the driver 74 is omitted, then the conduit 80 becomes a part of the inlet passage 78 to the intake manifold 34. By way of example, the fuel-air mixture source 42 is portrayed as a carburetor. Air enters the engine 10 at the top of the housing 68, and passes via an air cleaner 82 into a central passage 84 of the housing 68. The configuration of the housing 68 provides for a location, indicated in phantom, for the venturi 86 of a carburetor and, by way of alternative embodiment, provides for a location, indicated in phantom, for a fuel injection assembly 88. An air-fuel mixture provided by the venturi 86 or by the fuel-injection assembly 88 is drawn into the conduit 80 by suction developed in respective ones of the intake strokes of the respective cylinders 12A-12D. The suction is enhanced by inclusion of the driver 74 in an optional embodiment of the engine 10. An exhaust manifold 90 connects between an exhaust pipe 92, located at the base of the housing 68, and the exhaust valves 22 of the respective cylinders 12.

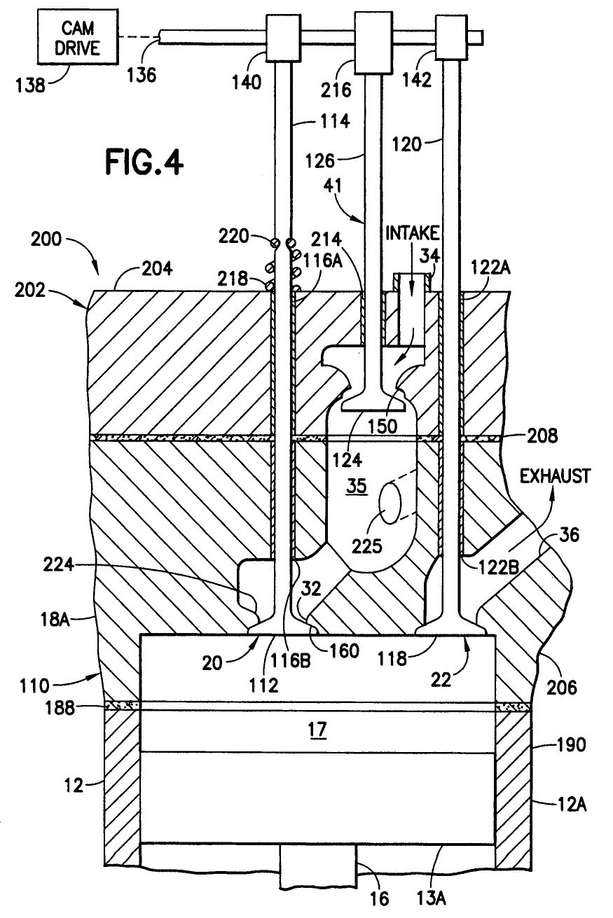

FIG. 4 shows a sectional view of an engine 110 having a construction similar to that of the engine 10 of FIG. 1, but having the valves arranged to be driven by a single camshaft, rather than the plural camshafts of the engine 10. This reduces complexity in the construction of the engine. In addition, the construction of the engine 110 includes the locating of a holding tank within the housing of a valve assembly located in the cylinder head of the engine. Furthermore, the construction of the engine 110 provides for the sharing of a holding tank among two cylinders of the engine, this being in accordance with the intake manifold branch 34A of FIG. 3.

As was noted in FIG. 1, the holding valve may be constructed in the form of a reed valve or a cam-driven valve or a crankshaft-driven valve. In FIG. 4, the holding valve 41 is constructed as a cam-driven valve. The cam-driven holding valve 41 introduces additional complexity to the engine 110, not found in the engine 10, due to the valve stem and additional cam which pushes against the valve stem. However, use of the cam drive for the holding valve presents the capability of variable valve timing for the operation of the holding valve, as described above with reference to the timing device 44 of FIG. 1. If further capability is required in the variable valve timing, then the employment of separate camshafts for the respective valves, as shown in FIG. 1, is preferred.

The engine 110 has a cylinder head 18A with a valve assembly 200. A housing 202 of the valve assembly 200 is constructed of an upper section 204 and a lower section 206 which are connected via a gasket 208 located at an interface between the two housing sections 204 and 206. Some of the engine components shown in FIG. 4 are essentially the same as corresponding components shown in FIG. 1 and, for convenience, are identified by the same reference numerals in both of the drawing figures. The lower housing section 206 connects via a gasket 188 to a cylinder block 190, the cylinder block 190 including the cylinder 12 and the piston 13A (previously described with reference to FIG. 1) which, in conjunction with the lower housing section 206, define the combustion chamber 17.

The lower section 206 of the housing 202 includes the intake port 32 connecting with the combustion chamber 17 via a head 112 of the intake valve 20, and the exhaust port 36 connecting with the combustion chamber 17 via a head 118 of the exhaust valve 22. The head 112 of the intake valve 20 lifts off of a seat 160 during an opening of the intake valve 20. The stem 114 of the intake valve 20 extends via valve guides 116B and 116A, respectively, in the housing sections 206 and 204 to contact a cam 140 on a camshaft 136 driven by a drive 138. The stem 120 of the exhaust valve 22 extends via valve guides 122B and 122A, respectively, in the housing sections 206 and 204 to contact a cam 142 on the camshaft 136 driven by the drive 138.

Also included in the valve assembly 200 is the holding valve 41 with a stem 126 that extends via a valve guide 214 in the upper housing section 204 to contact a cam 216 on the camshaft 136. A head 124 of the holding valve 41 is positioned by the valve stem 126 against a valve seat 150 in the upper housing section 204 upon a closing of the holding valve 41. The head 124 of the holding valve 41 lifts off of the seat 150 during an opening of the holding valve 41. Intake air from the intake manifold 34 (FIGS. 3 and 4) passes via the holding tank 35, the holding valve 41 and the intake valve 20 into the combustion chamber 17. Exhaust gasses exit the combustion chamber 17 via the exhaust valve 22 and the exhaust port 36 to pass into the exhaust manifold 90 (FIG. 3).

An exemplary valve retraction spring 218 is shown encircling the stem 114 of the intake valve 20. The upper end of the spring 218 engages in a notch 220 which encircles the stem 114, and the lower end of the spring 218 pushes against the upper housing section 204 to urge the stem 114 towards the cam 140 to maintain contact with the cam 140, and to seat the intake valve 20 in its seat 160 upon rotation of the cam 140 to the valve-seating part of the camshaft cycle. Similar arrangements of retraction springs (not shown in FIG. 4) may be provided for respective ones of the valve stems 120 and 126 for maintaining contact between these valve shafts and their respective cams 142 and 216, and for seating the corresponding valve heads 118 and 124 in their seats when the valves are to be closed.

In accordance with this embodiment of the invention, the valve assembly 200 is provided with the holding tank 35 that is located at the interface of the upper housing section 204 with the lower housing section 206, such that a portion of the holding tank 35 is located in the upper housing section 204, and a further portion is located in the lower housing section 206. The holding tank 35 is shared by one of the cylinders 12 (identified in FIGS. 3 and 4 as the cylinder 12A) as well as with a further cylinder 12 (not shown in FIG. 4 but identified as the cylinder 12B in FIG. 3) that is coupled to the holding tank 35 by a passage 225 formed within the lower housing section 206. The head 124 of the holding valve 41 is portrayed in FIG. 4 as being located in an upper portion of the holding tank 35 (within the space of the upper housing section 204, above the gasket 208) in an open state of the holding valve 41, wherein the valve head 124 is lifted away from the holding-valve seat 150. During assembly of the valve assembly 200, prior to attachment of the upper housing section 204 to the lower housing section 206, the holding-valve stem 126 is positioned in the valve guide 214 with the holding-valve head 124 located in the upper portion of the holding tank 222. Thereafter, a valve retraction spring is attached to the holding-valve stem 126 to hold the valve head 124 within the upper portion of the holding tank 35. Then the upper housing section 204 can be attached to the lower housing section 206 with the gasket 208 located between the two housing sections 204 and 206, thereby to complete formation of the housing 202. Thereupon, the intake-valve stem 114 and the exhaust-valve stem 120 are inserted through their respective valve guides and secured by their respective retraction springs to the housing 202.

In the operation of the engine 110, during the compression stroke, while the intake valve 20 is still open, the gases driven out of the combustion chamber 17 by the rising piston 13A pass by the intake-valve head 112 into a passage 224, located behind the valve head 112. The passage 224 is located off to the side of, and below the holding tank 35 so as to enable a positioning of the intake-valve stem 114 outside of the holding tank 35. The passage 224 extends to the bottom of the holding tank 35, and serves as a conduit to the holding tank 35, via which conduit, the intake gasses of the intake stroke pass from the holding tank 35 of the intake manifold 34 into the cylinder 12A and, via which conduit, the excess intake gases of the initial phase of the compression stroke pass from the combustion chamber 17 to the holding tank 35. In similar fashion, the passage 225 serves as an entrance for the intake gasses of the intake stroke from the intake manifold 34 and via the holding tank 35 into the combustion chamber 17 of the further cylinder 12B (not shown in FIG. 4 but shown in FIG. 3), and which shares the holding tank 35 of the manifold branch 34A.

FIG. 5 shows a construction of the invention in an inline, four-cylinder engine 330 with two of the four cylinders sharing a first of two holding tanks, and with the remaining two of the four cylinders sharing a second of the two holding tanks. In addition, in this engine, a holding tank is constructed with a relatively large transverse dimension and a relatively small vertical dimension to facilitate emplacement of the engine in a front engine compartment of an automobile without impairing forward vision of a driver of the automobile. In the drawing, each cylinder is shown with its intake valve, the exhaust valve being deleted to simplify the drawing. With respect to the holding tanks and the holding valves, each of the two holding tanks is shown operating with two holding valves in accordance with the arrangement portrayed in FIG. 3. It is understood, with respect to FIG. 5, that each of the holding valves can be constructed in the form of a reed valve, as has been discussed above, rather than as a cam drive valve, to provide for an engine of reduced complexity. However, the embodiment of FIG. 5 is constructed in accordance with the arrangement of FIG. 4 with cam-driven holding valves to demonstrate how a single camshaft can be used in the inline, four-cylinder engine for driving all of the intake valves, the exhaust valves and the holding valves.

The feature of sharing holding tanks is accomplished in this form of four-stroke engine wherein the timing of the piston strokes of the respective cylinders provides for two of the four pistons that are moving in their respective two cylinders towards their common cylinder head concurrently, but wherein the operation of the remaining two pistons in their respective two cylinders is delayed from the operation of the first of the two pistons by one quarter of the four-stroke cycle. As an example of such a configuration of an engine, with each of the foregoing pairs of cylinders, in a first of the paired cylinders (the middle cylinders of FIG. 5), the intake stroke for the first cylinder occurs concurrently with the power stroke of the second cylinder. In corresponding fashion, in the second of the paired cylinders (the outer cylinders of FIG. 5), the compression stroke in the first cylinder occurs concurrently with the exhaust stroke in the second cylinder. While this operational principle is readily demonstrated for the case of a single bank of four cylinders with their respective pistons connected to a common crankshaft, it is to be understood that the principles of operation of the invention apply to more complex engines, such as an engine having two banks of four cylinders.

The operational principle of the engine is demonstrated further, with reference to the sixth graph of FIG. 2, wherein the above staggered operation of the piston strokes in each pair of the cylinders presents opportunities for opening the holding valve associated with a single one of the holding tanks. Upon inspection of the second, fourth, fifth and sixth graphs, it is observed that the holding valve opens concurrently with an opening of one of the intake valves, and closes concurrently with a termination of that intake stroke. The intake valve, itself, remains open well into the interval of the following compression stroke. The opening of the holding valve is repeated upon the opening of the second of the intake valves, with closure of the holding valve occurring concurrently with a termination of that intake stroke. Furthermore, only one of the intake valves is open at any one instant of time. This demonstrates that in the sharing of a single holding tank by both the first and the second cylinders of a cylinder pair, the operation of the second cylinder does not interfere with the operation of the first cylinder. Conversely, the operation of the first cylinder does not interfere with the operation of the second cylinder.

FIG. 5 shows an engine 330 having four cylinders 332, 334, 336 and 338 arranged in line within a cylinder block 340, and an adjoining cylinder head 341 having a valve assembly 342 disposed within a housing 344 composed of an upper section 346 and a lower section 348. The valve-assembly housing 344 is secured to the upper surface of the cylinder block 340 with a gasket 350 located along an interface between the cylinder head 341 and the cylinder block 340. In the housing 344, the upper section 346 is secured to the lower section 348 with a gasket 352 located along an interface between the upper section 346 and the lower section 348. The valve assembly 342 provides separate sets of intake valve and exhaust valve, as well as a spark plug for each of the cylinders 332, 334, 336 and 338; however, in order to simplify the drawing, there are shown only the intake valves 354, 356, 358 and 360 respectively for the cylinders 332, 334, 336 and 338.

Each of the intake valves 354, 356, 358 and 360 comprises respectively a valve head 362, 364, 366 and 368, and further comprises respectively a valve stem 370, 372, 374 and 376. The intake valves 354, 356, 358 and 360 are driven by a camshaft 378 having four cams 380, 382, 384 and 386 making contact respectively with the valve stems 370, 372, 374 and 376. The engine 330 further comprises four pistons 388, 390, 392 and 394 located respectively in the cylinders 332, 334, 336 and 338, and a crankshaft 396 driven by the pistons 388, 390, 392 and 394, the pistons 388, 390, 392 and 394 being connected respectively by connecting rods 398, 400, 402 and 404 to the crankshaft 396. The crankshaft 396 is supported by bearings 406.

Upon rotation of the crankshaft 396, the pistons 388, 390, 392 and 394 move with translatory motion along their respective cylinders 332, 334, 336 and 338 towards and away from the cylinder head 341. Rotation of the camshaft 378 is at a rate of one revolution within one four-stroke interval of the engine 330, and is synchronized with rotation of the crankshaft 396 that rotates at a rate of two revolutions within one four-stroke interval of the engine 330. Synchronization of the camshaft 378 with the crankshaft 396 may be accomplished by a timing device, such as the timing device 44 of FIG. 1 (not shown in FIG. 5). Upon rotation of the camshaft 378, the intake valves 354, 356, 358 and 360 move with translatory motion along their respective valve stems 370, 372, 374 and 376 towards and away from the camshaft 378.

Included within the cylinder head 341 is a set of intake ports 408, wherein one intake port 408 is provided at the top of each cylinder 332, 334, 336 and 338 for receiving a respective one of the valve heads 362, 364, 366 and 368. Each of the intake ports 408 opens into the combustion chamber 410 of the respective cylinder 332, 334, 336 and 338, and has a valve seat 412, at the location wherein the intake port opens into the combustion chamber, for receiving the respective valve head 362, 364, 366 and 368 upon retraction of the valve head by the camshaft 378. Retraction of an intake valve by the camshaft results in a closure of the corresponding intake port 408 and a cessation of communication between the intake port 408 and the combustion chamber 410. Advancement of an intake valve, away from its intake port 408, by the camshaft 378 results in an opening of the corresponding intake port 408 for communication with the combustion chamber 410.

In accordance with the invention, a reduced number of holding tanks, namely, two holding tanks 414 and 416, for operation with the four cylinders 332, 334, 336 and 338 in the example provided by FIG. 5, are located in the cylinder head 341. The locations of the holding tanks 414 and 416 are provided at the gasket 352 so that a portion of each of the tanks 414 and 416 extends into the upper housing section 346, and a further portion extends also into the lower housing section 348. This arrangement of the tanks 414 and 416 facilitates construction of the tanks by reducing the amount of milling required in each of the housing sections 346 and 348. A portion of the valve stem 372 and a portion of the valve stem 374 are cut away in FIG. 5 to show the holding tanks. Passages 418 and 420 are formed within the lower housing section 348 to connect the holding tank 414 with the intake ports 408 respectively of the cylinders 334 and 336. Passages 422 and 424 are formed within the lower housing section 348 to connect the holding tank 416 with the intake ports 408 respectively of the cylinders 332 and 338. The passages 418, 420, 422 and 424 are shown in FIG. 5 as being straight to facilitate construction of these passages by a milling operation, it being understood that these passages may be provided with a curved configuration if desired, in which case construction may be performed by a molding process.

The holding tank 414, which may be part of the intake manifold branch 34A of FIG. 3, is provided with a holding valve 426 disposed in a holding port 428 of the tank 414. An opening of the holding valve 426 connects the holding tank 414 via a conduit 430 to an arm 72 (not shown in FIG. 5, but shown in FIG. 3) of the intake manifold 34. The holding tank 416, which may be part of the intake manifold branch 34B of FIG. 3, is provided with a holding valve 432 disposed in a holding port 434 of the tank 416. An opening of the holding valve 432 connects the holding tank 416 via a conduit 436 to an arm 72 (not shown in FIG. 5, but shown in FIG. 3) of the intake manifold 34. The holding valve 426 has a valve head 438 and a valve stem 440, the valve stem 440 positioning the head 438 within the holding port 428 and being pressed by a spring (not shown) against a cam 442 carried on the camshaft 378. The holding valve 432 has a valve head 444 and a valve stem 446, the valve stem 446 positioning the head 444 within the holding port 434 and being pressed by a spring (not shown) against a cam 448 carried on the camshaft 378. Upon rotation of the camshaft 378, the cam 442 drives the valve stem 440 for opening and closing the holding valve 426, and the cam 448 drives the valve stem 446 for opening and closing the holding valve 432. An opening of the holding valve 426, 432 is characterized by a downward movement of the valve head 438, 444 into the holding tank 414, 416 respectively, and an upward movement of the valve head 438, 444 provides for a closing of the respective holding valve 426, 432.

The shape of a holding tank is determined by the location of the tank with reference to the positions of other elements in the cylinder head 341, subject to the condition that the volume of the holding tank is related to the volume of a combustion chamber as has been explained above. When calculating the volume of a holding tank, such as the tank 414, it is necessary to include the volume of the passages, such as the passages 418 and 420, connecting the tank to the intake ports 408 because these passages serve to store engine gasses as does the holding tank. The capacity for providing different shapes to individual ones of the holding tanks disposed within the cylinder head 341 facilitates arrangement of the components of the cylinder head 341, and thereby aids in reducing the complexity of the construction of the engine 330.

FIG. 5 demonstrates the capacity for providing different shapes to individual ones of the holding tanks, wherein the holding tank 414 is configured with an elongated rectangular shape, while the holding tank 416 is configured as a pancake extending a relatively short distance into each of the lower housing section 348 and the upper housing section 346. In the pancake shape, the holding tank has a relatively short dimension in a direction generally parallel to the axis of a cylinder, and has a relatively long dimension in a plane generally perpendicular to the cylinder axis. This shape of holding tank minimizes engine height to facilitate emplacement of the engine in the front engine compartment of an automobile, this being advantageous for reasons of styling and for driver visibility. Again, by way of further example in the construction of the holding tanks, the holding tank 416 is shown passing behind the holding tank 414 in the view of the engine 330 presented in FIG. 5.

With reference to both FIGS. 2 and 5, the first stroke of the four-stroke engine cycle is the induction stroke. The succession of the induction strokes in the respective cylinders follows the firing order, such that the induction stroke in the right middle cylinder occurs 180 degrees after the induction stroke in the left end cylinder. The second stroke of the four-stroke engine cycle is the compression stroke. Similarly to the succession of induction strokes, the succession of the compression strokes in the respective cylinders follows the firing order, such that the compression stroke in the right middle cylinder occurs 180 degrees after the compression stroke in the left end cylinder. By extension of this reasoning, it is apparent that the history of the four-stroke operation in each of the cylinders is delayed from the operation in some other cylinder by 180 degrees, 360 degrees, or 540 degrees depending on the positions of the cylinders in the firing order. As described above with reference to the graphs of FIG. 2, the invention is practiced with the sharing of a holding tank within the intake manifold by two cylinders for which the respective operations are delayed from each other by 360 degrees of crankshaft rotation. This places the active interval (wherein there is a transfer of gas between tank and cylinder) for one of the cylinders in the inactive interval (wherein there is no transfer of gas between tank and cylinder) of the other of the two cylinders. Thereby, as has been noted above, each of the two cylinders can act with the holding tank without interference from the other of the two cylinders.

With respect to the operation of the engine 330, the linear arrangement of the four pistons 388, 390, 392 and 394 along the crankshaft 396 synchronizes the movements of the four pistons such that the two end pistons 388 and 394 are in step (360 degrees out of phase), and the two middle pistons 390 and 392 are in step (360 degrees out of phase). The middle pistons 390 and 392 are 180 degrees out of phase with the end pistons 388 and 394 such that when the two middle pistons are at top dead center (as shown in FIG. 5), the two end pistons are at bottom dead center (as shown in FIG. 5). Implementation of the four-stroke cycle operation is obtained by ignition of the fuel-air mixture in successive ones of the cylinders in a prescribed order, such that each ignition occurs 180 degrees of crankshaft rotation after the previous ignition in the sequence of ignitions. In this sense, the rotating crankshaft can be regarded as setting the timing of the operations in all of the cylinders. The order of the ignitions in the respective cylinders may be referred to as the firing order, and is indicated in FIG. 5 by the sequence of numbers located beneath the engine. The firing order is shown as the first ignition in the cylinder 332 (left end cylinder), the second ignition in the cylinder 336 (right middle cylinder), the third ignition in the cylinder 338 (right end cylinder), and the fourth ignition in the cylinder 334 (left middle cylinder). This is followed by a repetition of the firing order, such that the fifth ignition is in the cylinder 332. With reference to the angle of rotation of the crankshaft 396, if the first ignition takes place at an arbitrary phase angle considered to be at a reference angle of zero degrees, the next ignition takes place at a crankshaft phase angle of 180 degrees, the third ignition takes place at a crankshaft phase angle of 360 degrees, and the fourth ignition takes place at a crankshaft phase angle of 540 degrees. These angles are shown at the bottom of FIG. 5 in registration with numbers designating the firing order. In corresponding fashion, the cams 442 and 448 for operation of the holding valves 426 and 432 (respectively for the holding tanks 414 and 416) are arranged on the camshaft 378 to open their respective holding valves at times related to the openings of the intake valves and terminations of the induction strokes, as described above with reference to the graphs of FIG. 2.

The sequence of operations of the engine 330 is shown in FIG. 5 by the succession of the piston and valve positions of the respective cylinders. This is visualized below by consideration of activity of each of the cylinders.

With respect to the left middle cylinder 334, the piston 390 is shown at the top of the cylinder with the intake valve 364 open for initiation of the induction stroke. The holding valve 426 of the holding tank 414 is open to provide a clear passage for intake gas (air-fuel mix) through the intake manifold 34 which, in this embodiment of an engine employing the invention, is located largely within the housing 344 of the valve assembly 342.

With respect to the right end cylinder 338, the piston 394 is shown at the bottom of the cylinder with the intake valve 360 is held open during the initial phase of the compression stroke. The holding valve 432 of the holding tank 416 is closed to block a passage for intake gas through the intake manifold 34. Thus, the intake gas expelled from the cylinder 338 is stored in the holding tank 416.

With respect to the right middle cylinder 336, the piston 392 is shown at the top of the cylinder with the intake valve 358 closed for initiation of the power stroke. The holding valve 426 of the holding tank 414 is open to provide a clear passage for intake gas through the intake manifold 34 for the induction stroke in the left middle cylinder 334.

With respect to the left end cylinder 332, the piston 388 is shown at the bottom of the cylinder with the intake valve 354 closed for the exhaust stroke. The holding valve 432 of the holding tank 416 is closed to block a passage for intake gas through the intake manifold 34. Thus, the intake gas expelled from the cylinder 338 during the initial phase of the compression stroke is stored in the holding tank 416.

The alternate opening of the two holding valves 426 and 432 arises by virtue of a delay of one-quarter of the four-stroke cycle (180 degrees of rotation of the crankshaft 396) between the operation of a piston 388 or 394 associated with the holding tank 416 and the operation of either one of the pistons 390 or 392 associated with the other holding tank 414. This may be seen by inspection (in FIG. 5) of the piston positions corresponding to the firing order and the crankshaft rotation. Also, with reference to the bottom two graphs of FIG. 2, which portrays operations of the holding valves for the two holding tanks, the openings of an individual one of the holding valves are spaced apart in time by one half of the four-stroke cycle. This corresponds to 360 degrees of crankshaft rotation. However, in view of the above-noted delay of one-quarter of the four-stroke cycle between the operations of the pistons of one holding tank and the pistons of the other holding tank, it becomes apparent that an opening of the second holding valve would occur during an interval when the first holding valve is closed.

Thereby, in accordance with a feature of the invention, the operations of the first and the second holding valves are staggered by the one-quarter cycle delay of the four-stroke cycle between the operation of a first plurality of cylinders associated with a first of the holding tanks and the operation of a second plurality of cylinders associated with a second of the holding tanks. The staggering of the operations provides that one of the holding valves is open only during a period of time when the other of the holding valves is closed. This results advantageously in improved uniformity in the flow of gasses through the intake manifold.

It is to be understood that the above-described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. An internal combustion engine comprising:
an intake manifold, an exhaust manifold, a cylinder, a crankshaft, and a piston connected by a connecting rod to the crankshaft and being movable with reciprocating motion within the cylinder upon rotation of the crankshaft, the piston motion providing a succession of four strokes including an induction stroke, a compression stroke, a power (expansion) stroke and an exhaust stroke, wherein a maximum spacing of the piston from a cylinder head of the engine defines a maximum volume of a combustion chamber in the cylinder; and
wherein the engine further comprises a valve assembly having an intake valve for communicating gas between the intake manifold and the cylinder, an exhaust valve for communicating engine exhaust gases between the cylinder and the exhaust manifold, and a holding valve located within the intake manifold for enabling a conduit of the intake manifold to serve as a holding tank;
a spark ignition device for igniting fuel within the combustion chamber to accomplish a burning of the fuel during the power stroke; and
a timing device synchronized with rotation of the crankshaft for operating the intake valve and the exhaust valve to provide for intervals of closure and opening of the intake valve and the exhaust valve;
wherein the compression stroke serves to compress a quantity of gas within the combustion chamber in preparation for the power stroke, the compression-stroke gas being a mixture of air and fuel for delivery of fuel to the combustion chamber via the intake manifold, or air without fuel for delivery of fuel to the combustion chamber via injection into the cylinder, the compression stroke providing a reduction in volume of the gas characterized by a compression ratio;
the power stroke provides for an expansion in volume of a quantity of gas within the combustion chamber, characterized by an expansion ratio, the gas in the power stroke being a mixture of air, fuel, and products of combustion, utilization of the holding tank providing for a value of the expansion ratio that is greater than the compression ratio for efficient operation of the engine;
the holding valve, in a closed state, establishes the holding tank from the conduit of the intake manifold, by blocking a passage within the conduit for intake gas, between the holding valve and the intake valve;
the holding valve, in an open state, reopens the passage within the conduit of the intake manifold to convert the holding tank back to the conduit for passage of intake gas via the intake manifold from a source of the intake gas to the intake valve; and
operation of the engine is characterized by a sequence of valve operations including: (1) an opening of the holding valve at the inception of the induction stroke, and a closing of the holding valve at the termination of the induction stroke; (2) an operational sequence for the exhaust valve to open the exhaust valve during a terminal portion of the power stroke or at the termination of the power stroke, and to close the exhaust valve at the termination of the exhaust stroke; and (3) an operational sequence for the intake valve to open the intake valve at the inception of the induction stroke, and to close the intake valve during a terminal portion of the compression stroke, wherein the terminal portion of the compression stroke begins more than 100 degrees of crankshaft rotation after bottom dead center of the compression stroke, and wherein the terminal portion of the compression stroke terminates prior to generation of the spark by the spark ignition device.

2. The engine according to claim 1, wherein the terminal portion of the compression stroke extends over a region of crankshaft rotation from 60 degrees before top dead center in the compression stroke to 35 degrees before top dead center in the compression stroke.

3. The engine according to claim 1, wherein the timing device provides for said sequence of valve operations by a mechanical driving of each of said holding valve, said intake valve, said exhaust valve.

4. The engine according to claim 3, wherein said mechanical driving includes a cam-driving operation for each of said holding valve, said intake valve, said exhaust valve.

5. The engine according to claim 4, wherein the engine further comprises a fluid driver comprising a turbocharger or a supercharger for driving intake gas into the intake manifold, the intake gas being a mixture of air and fuel for delivery of fuel to the combustion chamber via the intake manifold, or air without fuel for delivery of fuel to the combustion chamber via injection of the fuel into the cylinder.

6. The engine according to claim 1 wherein said holding valve comprises a reed valve responsive to intake vacuum of the induction stroke, the read valve opening in the presence of a relatively large vacuum at the inception of the induction stroke and closing in the presence of the relatively small vacuum at the termination of the induction stroke.

7. An engine according to claim 1, wherein said cylinder is a first cylinder, the engine further comprising:
a plurality of cylinders including said first cylinder, all of said plurality of cylinders connecting to said cylinder head and having a plurality of pistons movable by said crankshaft with reciprocating motion within respective ones of said cylinders, the piston motion in each of the respective cylinders providing a succession of four strokes including an induction stroke, a compression stroke, a power stroke and an exhaust stroke, wherein a maximum spacing of a piston from the cylinder head defines a maximum volume of a combustion chamber in a cylinder of the engine;
wherein the valve assembly of the engine further comprises for each of the plurality of cylinders an intake valve and an exhaust valve, and the engine further comprises for each of the plurality of cylinders a spark ignition device for igniting fuel within the combustion chamber to accomplish a burning of the fuel during the power stroke;
wherein said conduit of said intake manifold is connected to two of said cylinders by their respective intake valves to enable a sharing of said conduit by said two cylinders for communicating gas between the intake manifold and each of the two cylinders, said exhaust valves of the plurality of cylinders connecting the respective cylinders for communicating engine exhaust gases between the cylinder and the exhaust manifold, and said holding valve enabling said conduit of the intake manifold to serve as a holding tank for each of the two cylinders;
said timing device offsets the four-stroke sequence of operation of the piston and the intake valve of a first of said two cylinders by 360 degrees of crankshaft rotation from the four-stroke sequence of operation of the piston and the intake valve of the second of said two cylinders; and
said timing device provides the operational sequence for the holding valve twice during 360 degrees of rotation of the crankshaft such that an opening of the holding valve occurs a first time in correspondence with an induction stroke of the first of the two cylinders, and occurs a second time in correspondence with an induction stroke of the second of the two cylinders.

8. The engine according to claim 7, wherein said plurality of cylinders is a first plurality of cylinders, the engine further comprises a second plurality of cylinders connecting to said cylinder head and having pistons movable by said crankshaft with reciprocating motion within respective ones of said second plurality of cylinders, and wherein the valve assembly provides an intake valve and an exhaust valve to each cylinder of said second plurality of cylinders;
the holding tank is a first holding tank located in a first branch of said intake manifold, and the holding valve is a first holding valve; and wherein said intake manifold comprises a second branch having a conduit therein, and the engine further comprises a second holding valve for establishing a second holding tank in the conduit of said second branch of said intake manifold; and
wherein, with respect to a first cylinder and a second cylinder of said second plurality of cylinders and with respect to said second branch of said manifold, said timing device provides the operational sequence for the second holding valve twice during 360 degrees of rotation of the crankshaft such that an opening of the second holding valve occurs a first time in correspondence with an induction stroke of the first of the two cylinders, and occurs a second time in correspondence with an induction stroke of the second of the two cylinders.

9. The engine according to claim 8, wherein:
said first plurality of cylinders consists of two cylinders and said second plurality of cylinders consists of two cylinders;
first and second pistons in the two cylinders of said first plurality of cylinders translate within their respective cylinders in unison such that both the first and the second pistons are moving within their respective cylinders towards the cylinder head concurrently, but wherein the operation of the second piston is delayed from the operation of the first piston by one half of the four-stroke cycle such that the exhaust stroke of the first piston takes place during the compression stroke of the second piston;
first and second pistons in the two cylinders of said second plurality of cylinders translate within their respective cylinders in unison such that both the first and the second pistons are moving within their respective cylinders towards the cylinder head concurrently, but wherein the operation of the second piston is delayed from the operation of the first piston by one half of the four-stroke cycle;
operation of the pistons of the second plurality of cylinders is delayed relative to the operation of the pistons of the first plurality of cylinders by one quarter of the four-stroke cycle such that the pistons of the first plurality of cylinders advance toward the cylinder head while the pistons of the second plurality of cylinders retract away from the cylinder head; and
operations of the first and the second holding valves are staggered by the one-quarter cycle delay of the four-stroke cycle between operations of the first plurality of cylinders and the second plurality of cylinders to provide that one of the holding valves is open only during a period of time when the other of the holding valves is closed resulting in improved uniformity in the communication of gasses between the intake manifold and the cylinders of the first plurality and the second plurality of cylinders.
